(19) United States
(12) Patent Application Publication
(10) Pub. No.: US 2003/0002217 A1
(43) Pub. Date: Jan. 2, 2003

(54) Head suspension assembly, disk device, and head suspension assembly manufacturing method

(76) Inventor: Yusuke Ohinata, Tachikawa-shi (JP)

Correspondence Address: Pillsbury Winthrop LLP, Intellectual Property Group, 1600 Tysons Boulevard, McLean, VA, 22102, US

(21) Appl. No.: 10/158,842

(22) Filed: Jun. 3, 2002

(30) Foreign Application Priority Data
Jun. 29, 2001 (JP) 2001-199659

(51) Int. Cl. G11B 5/60

(52) U.S. Cl. 360/234.5

(57) ABSTRACT

A head suspension assembly of a hard disk drive has a slider chip including a magnetic head. The slider chip is attached on a flexure disposed to a suspension. At this moment, solder is set between copper lands respectively formed on three end surfaces of the slider chip and copper lands formed to the flexure in accordance with the former lands, all sets of the solder are simultaneously fused, and the slider chip is self-aligned with respect to the flexure by the surface tension of the solder.

### CROSS-REFERENCE TO RELATED APPLICATIONS

This application is based upon and claims the benefit of priority from the prior Japanese Patent Application No. 2001-199659, filed Jun. 29, 2001, the entire contents of which are incorporated herein by reference.

### BACKGROUND OF THE INVENTION

1. Field of the Invention

The present invention relates to a head suspension assembly incorporated in a disk device, a disk device, and a head suspension assembly manufacturing method.

2. Description of the Related Art

As a magnetic disk device, there has been conventionally known a hard disk drive (which will be simply referred to as an HDD hereinafter) which is used as an external storage device of, e.g., a computer system.

The HDD includes a magnetic disk provided in a case, a spindle motor which supports and drives to rotate the magnetic disk, a head suspension assembly (which will be referred to as an HSA hereinafter) having a head which reads/writes information with respect to the magnetic disk mounted at an end thereof, and a voice coil motor which oscillates the HSA.

The HSA has a slider chip to which the head is formed, a suspension having the slider chip attached at an end thereof through a flexure, and an arm which supports a base end portion of the suspension. A wiring pattern is formed on the suspension and the arm, the slider chip is bonded and fixed to the flexure on the wiring pattern, and the head is electrically connected to the wiring pattern.

Further, the HSA supports the base end portion of the arm by a bearing assembly so as to be capable of swiveling, and it can hence oscillate by the voice coil motor and move the head provided at the end of oscillation to an arbitrary position on the magnetic disk. That is, information can be read from and written into the magnetic disk by the head by rotating the magnetic disk and oscillating the HSA. Incidentally, at this moment, the slider chip slightly flies on the magnetic disk by the pressure of air generated by rotation of the magnetic disk. A surface of the slider chip which is opposed to the magnetic disk is called an Air bearing Surface (which will be referred to as an ABS hereinafter).

In recent years, with the increase in the throughput capacity of computers, applications which require highly advanced processing are becoming widespread and the quantity of data processed is increasing. Therefore, the demand for realization of larger capacity HDDs is increasing. Furthermore, as the HDD which is mounted on a portable machine such as a notebook computer, the demand for reduction in size is also increasing.

In order to realize an HDD with a large capacity and small dimensions, the recording density of the magnetic disk storage medium must be increased. As methods for increasing the recording density, increasing the linear recording density along the track direction and increasing the recording density along the radial direction of the magnetic disk while narrowing the track width and the track pitch are utilized.

In particular, in order to increase the linear recording density, data must be recorded on the magnetic disk with a steep magnetic gradient and sufficient magnetic strength. In order to realize this, a flying height of the slider chip from the magnetic disk must be stabilized, and a flying posture must be very stable.

In the case of manufacturing a conventional HSA, however, since the center (pivot) of the slider chip is mechanically positioned with respect to the flexure provided at the end of the suspension and attached by adhesive, displacement of the pivot, i.e., a tolerance is large, and it is very hard to set the attachment position of the slider chip to a designed value.

When the tolerance of the pivot deviates from the designed value and becomes large, a flying height of the slider chip deviates from a designed value, and a pitch or roll is generated in the slider chip, which leads to an unstable flying posture. When the flying posture of the slider chip becomes unstable, a steep magnetic gradient and sufficient magnetic strength cannot be imparted to the magnetic disk, and a linear recording density with respect to the magnetic disk cannot be increased. Also, reduction in size of the HDD and increase in the capacity of the HDD can not be attained.

### BRIEF SUMMARY OF THE INVENTION

In view of the above-described drawbacks, it is an object of the present invention to provide a head suspension assembly which enables a high-density recording with respect to a disk.

To achieve this aim, according to an embodiment of the present invention, there is provided a head suspension assembly, a slider chip including a head being attached to a suspension through a flexure, the slider chip being set on the flexure which is horizontally set, solder being set between at least one first land formed on the slider chip and at least one second land formed at a predetermined position on the flexure in accordance with this at least one first land, all sets of solder being simultaneously fused, the slider chip being subjected to self alignment and fixed to the flexure by utilizing the surface tension of the solder.

Further, according to the embodiment of the present invention, there is provided a head suspension assembly manufacturing method comprising: fixing and adjusting an inclination of a suspension in such a manner that a flexure becomes substantially horizontal; setting a slider chip on the flexure; setting solder between at least one first land formed on the slider chip and at least one second land formed at a predetermined position on the flexure in accordance with the at least one first land; simultaneously fusing all sets of solder; and subjecting the slider chip to self alignment with respect to the flexure by utilizing the surface tension of the solder.

According to the embodiments, the slider chip can be subjected to self alignment with respect to the flexure by utilizing the surface tension of the solder set between the first and second lands. Therefore, the slider chip does not have to be mechanically positioned and bonded to the flexure as with the prior art, and the slider chip can be accurately positioned and attached to the flexure.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view schematically showing an inner structure of a hard disk drive according to an embodiment of the present invention;

FIG. 2 is an enlarged bottom view showing the vicinity of an end of a head suspension assembly according to a first embodiment of the present invention;

FIG. 3 is a side view showing the vicinity of the end of the head suspension assembly illustrated in FIG. 2 from the horizontal direction;

FIG. 4 is a perspective view schematically showing a slider chip attached to the head suspension assembly depicted in FIG. 2 and its peripheral structure;

FIGS. 5A and 5B are views showing particle shapes of solder used for bonding the slider chip depicted in FIG. 4 to a flexure;

FIG. 6 is a view showing a modification that a shape of a land used for bonding the slider chip is modified;

FIG. 7 is a view showing a modification that a land used for bonding the slider chip is added;

FIG. 8 is a view for illustrating a method for subjecting the slider chip to self alignment by bonding four corners of the slider chip; and

FIG. 9 is an enlarged bottom view showing the vicinity of an end of a head suspension assembly according to a second embodiment of the present invention.

### DETAILED DESCRIPTION OF THE INVENTION

Embodiments according to the present invention will now be described in detail hereinafter with reference to the accompanying drawings.

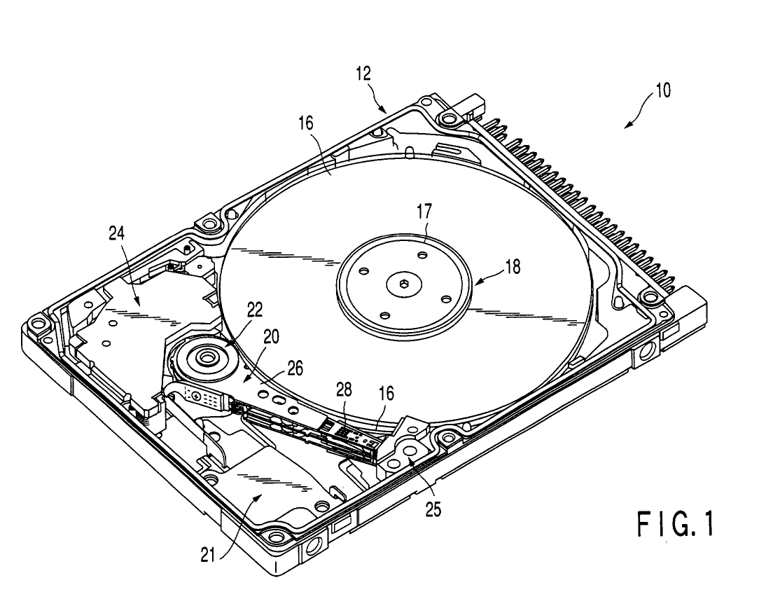

FIG. 1 is a perspective view showing a schematic structure of a hard disk drive 10 (which will be referred to as an HDD 10 hereinafter) (disk device) including a head suspension assembly 20 (which will be referred to as an HAS 20) according to an embodiment of the present invention.

The HDD 10 has a case 12 which is opened on the upper surface and has a rectangular box-like shape and a non-illustrated top cover which is screwed to the case by a plurality of screws and closes an opening at an upper end of the case. That is, FIG. 1 shows the state that the top cover is removed in order to illustrate the inner structure of the HDD 10.

In the case 12 are accommodated two magnetic disks 16 (disks) which are an example of a magnetic storage medium, a spindle motor 18 which supports and drives to rotate the magnetic disks 16, four HSAs 20 having at each end a later-described magnetic head which reads/writes data with respect to the both sides of the magnetic disk 16, a bearing assembly 22 which supports the HSAs 20 so as to be capable of swiveling with respect to the magnetic disks 16, a voice coil motor (which will be referred to as a VCM hereinafter) 24 used for swiveling and positioning each HSA 20, a ramp load mechanism 25 which holds the magnetic head of each HSA 20 at a position distanced from the magnetic disks 16 when that magnetic head has moved to the outermost periphery of the magnetic disks 16, and a base board unit 21.

Further, a non-illustrated printed circuit board which controls the operation of the spindle motor 18, the VCM 24 and the magnetic heads through the base board unit 21 is screwed on the outer surface of the bottom wall of the case 12.

Each magnetic disk 16 is formed on a base board formed of, e.g., glass or aluminium and has magnetic recording layers on the upper and lower surfaces thereof. The magnetic disk 16 is coaxially fitted to a non-illustrated hub of the spindle motor 18 and held by a clamp spring 17. Furthermore, the two magnetic disks 16 are driven to rotate by the spindle motor 18 at a predetermined speed.

The four HSAs 20 are caused to oscillate around the bearing assembly 22 by the VCM 24, and the magnetic head provided at each end is moved (sought) on a desired track on the magnetic disk 16. Then, data is read and written with respect to the magnetic disk 16 through the magnetic head.

As will be described later, the magnetic head is formed to the later-described slider chip used for forming a small gap between itself and the surface of the magnetic disk 16. This slider chip is attached to a later-described flexure provided at the end of the later-described suspension of the HSA 20, and pressure is applied to the slider chip in the direction of the magnetic disk by the spring function of the suspension. Moreover, during the operation of the HDD 10, the slider chip functions to cause the magnetic head to fly on the surface of the magnetic disk 16 by a substantially fixed distance by the air pressure generated by rotation of the magnetic disk 16.

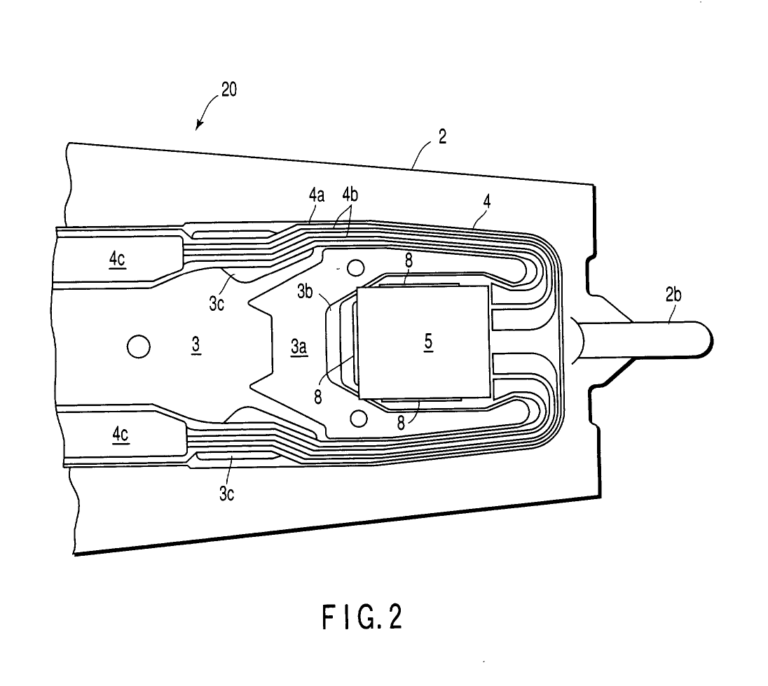

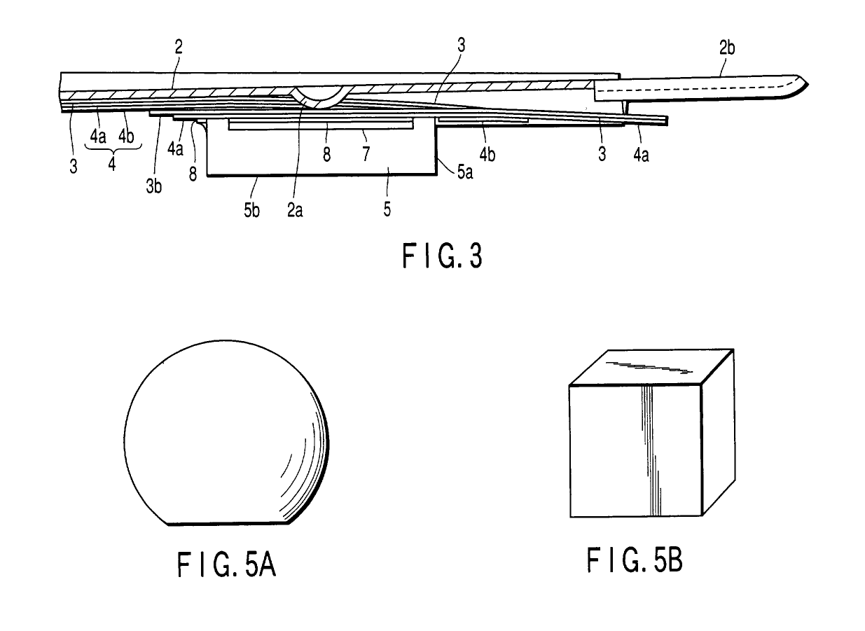

FIG. 2 is a partial bottom view showing the vicinity of the end portion of the HSA 20 according to a first embodiment of the present invention seen from the direction of the magnetic disk 16. In addition, FIG. 3 is a side view showing the vicinity of this end portion from the horizontal direction. It is to be noted that the flexure 3 is partially omitted for clarifying the illustration and only the suspension 2 is cut at the center in FIG. 3 as a cross-sectional view.

The HSA 20 has a suspension 2 formed by a thin plate of stainless steel at the end of the non-illustrated arm. A convex portion 2a which presses the slider chip 5 in the direction of the magnetic disk 16 is formed at a predetermined central position in the vicinity of the end of the suspension 2. This convex portion 2a is formed so as to protrude toward the lower surface side of the suspension 2 by partially thrusting a predetermined position of the suspension 2 from its upper surface side. Additionally, to the end of the suspension 2 is provided a lift tab 2b so as to protrude therefrom, which is supported by the above-described ramp load mechanism 25 when the magnetic head 6 is arranged at a position distanced from the magnetic disk 16.

The flexure 3 formed by a thin plate of stainless steel is accurately positioned and attached to the lower surface side of the suspension 2. The flexure 3 extends along the suspension 2 and forms a cantilever-like plate piece portion 3b (which will be referred to as a mount piece 3b hereinafter) used for mounting the slider chip 5 by forming a substantially-U-shaped hole 3a in the vicinity of the end of the flexure 3. This mount piece 3b is pressed by the convex portion 2a of the suspension 2 and slightly pushed down in the direction of the magnetic disk 16 from other portion. Further, a plurality of holes 3c are formed in the flexure 3.

A wiring pattern 4 connected to the magnetic head is formed on the surface of the flexure 3. The wiring pattern 4 is formed by patterning copper wires 4b on polyimide film 4a, it leads along the both edges in the longitudinal direction of the flexure 3 from a non-illustrated arm of the HSA 20 through the suspension 2 and extends to the surface of the mount piece 3b. There are four copper wires 4b of the wiring pattern 4 and they are used for writing and reading data. Each end of these wires 4b extends to the mount piece 3b. Each end of the four copper wires 4b also functions as a second land according to the present invention. It is to be noted that a cover layer 4c is provided on the copper wire 4b except a part in the vicinity of the end of the wiring pattern 4. In other words, the copper wire 4b is exposed only in the vicinity of the end of the wiring pattern 4.

A substantially rectangular block-like slider chip 5 is attached on the mount piece 3b through the polyimide 4a of the wiring pattern 4. As shown in FIG. 4, the slider chip 5 includes the magnetic head 6 at the end surface 5a on the side opposed to the ends of the copper wires 4b. Further, four connection terminals 6a, 6b, 6c and 6d of the magnetic head 6 which are electrically connected to each copper wire 4b are formed on the end surface 5a. These four connection terminals 6a, 6b, 6c and 6d also function as the first lands according to the present invention. It is to be noted that the surface 5b on the side of the slider chip 5 opposed to the magnetic disk 16 functions as an Air Bearing Surface 5b (which will be referred to as an ABS 5b hereinafter) which causes the slider chip 5 to float from the surface of the magnetic disk 16 through an air layer generated by rotation of the magnetic disk 16.

Meanwhile, in order to increase the capacity of the HDD 10 while reducing the size, the recording density of the magnetic disk 16 must be raised. As methods of increasing the recording density, increasing the linear recording density along the track direction of the magnetic disk 16 and increasing the recording density along the radial direction of the magnetic disk 16 by narrowing the track width and the track pitch are possible. For example, in order to increase the linear recording density, data must be recorded on the magnetic disk 16 with a steep magnetic gradient and sufficient magnetic strength. Accordingly, a flying height of the slider chip 5 from the magnetic disk 16 must be stabilized and the flying posture must be caused to enter the very stable state.

Therefore, in this embodiment, the center (pivot) of the slider chip 5 is accurately positioned with respect to the mount piece 3b and the slider chip 5 is attached to the mount piece 3b. As a result, the displacement of the pivot, namely, a tolerance can be suppressed to approximately several aim, and the flying posture of the slider chip 5 can be stabilized.

A method of accurately positioning the pivot of the slider chip 5 will now be described with reference to FIG. 4.

Lands 7 (first lands) formed by copper foils (only one land is shown) are previously formed on three end surfaces 5c, 5d and 5e of the slider chip 5 (except an end surface 5a including the magnetic head 6) for positioning. Each of the three lands 7 is formed into a rectangular shape whose length does not exceed each of the end surfaces 5c, 5d and 5e. In particular, the two lands 7 formed to the opposed end surfaces 5c and 5e are formed with the same length and the same shape. On the other hand, lands 8 (second lands) formed by copper foils (see FIGS. 2 and 3) are also previously formed at corresponding positions on the polyimide 4a on the mount piece 3b in accordance with the respective lands 7 of the slider chip 5. The three lands 8 on the polyimide 4a are formed to have the same length as the corresponding lands 7 of the slider chip 5. Furthermore, the width of each of the lands 7 and 8 is designed to 10 μm or lower, and each of the lands 7 and 8 is positioned in such a manner that a distance between the corresponding lands 7 and 8 is 0 to 25 μm.

Moreover, by bonding the copper wires 4b and the connection terminals 6a, 6b, 6c and 6d together with the lands 7 and 8, the slider chip 5 is attached on the polyimide 4a on the mount piece 3b. By doing so, the respective connection terminals 6a to 6d and the copper wires 4b are simultaneously electrically connected to each other.

In this case, the inclination of the suspension 2 is first adjusted and fixed in such a manner that the mount piece 3b becomes substantially horizontal. In this state, the pivot of the slider chip 5 is positioned with respect to the mount piece 3b, and the slider chip 5 is set on the polyimide 4a on the mount piece 3b. In other words, the slider chip 5 is set in an area surrounded by the three mounts 8 on the polyimide 4a and the tip of four copper wires 4b. At this moment, the slider chip 5 does not have to be accurately positioned nor temporarily bonded by using, e.g., an adhesive. In addition, at this moment, the three lands 8 formed on the polyimide 4a function as stoppers which mechanically position the slider chip 5 by utilizing their thicknesses.

Additionally, non-illustrated elongated solder is set between the lands 7 respectively formed on the end surfaces 5c, 5d and 5e of the slider chip 5 and the lands 8 formed on the polyimide 4a, and solder is set between the connection terminals 6a to 6d formed on the end surface 5a of the slider chip 5 and the copper wires 4b of the wiring pattern 4. For example, the solder which connects the respective connection terminals 6a to 6d with the copper wires 4b has a shape such as shown in FIG. 5A or 5B, and it does not roll when set on the horizontally-arranged copper wires 4b. In particular, the substantially spherical solder shown in FIG. 5A is preferable since it has an excellent laser irradiation efficiency. Further, the non-illustrated solder which connects the elongated lands 7 and 8 is formed to have a length corresponding to the length of the lands 7 and 8 and a shape by which it does not roll.

As described above, in the state that the slider chip 5 is set at a predetermined position on the polyimide 4a and the solder is set at predetermined positions, all sets of solder are simultaneously irradiated with the laser beam and concurrently fused. As a result, the fused solder spreads to the connection terminals 6a to 6d, the copper wires 4b and the lands 7 and 8, and the four end surfaces 5a, 5c, 5d and 5e of the slider chip 5 are pulled in the directions distanced from each other by the surface tension of the solder. Consequently, the pivot of the slider chip 5 is automatically positioned (self alignment) at a predetermined position on the mount piece 3b.

At this moment, the quantity of each set of solder, and shapes, sizes, positions or the like of the connection terminals 6a to 6d, the copper wires 4b and the lands 7 and 8 are accurately determined in advance. In particular, the two lands 7 formed to the opposed end surfaces 5c and 5e of the slider chip 5 and the two lands 8 formed to the polyimide 4a in accordance with the former lands are designed to have the same shape, size, position or the like in such a manner that the same quantity of the solder pulls the slider chip 5 by the same surface tension.

Furthermore, after self alignment of the slider chip 5, when the fused solder is cooled down and becomes hard, the slider chip 5 is attached and fixed on the polyimide 4a. Incidentally, when the displacement of the slider chip 5 is generated before the solder is cooled down, the displacement is generated at the pivot of the slider chip 5. However, by adopting bonding using the solder as with this embodiment, self alignment of the slider chip 5 can be repeated by again fusing the solder.

Moreover, according to this embodiment, even if the displacement of the pivot is generated when the slider chip 5 is set on the polyimide 4a, the displacement of the pivot can be automatically corrected by the self alignment effect utilizing the surface tension of the solder. A quantity of correction at this moment varies depending on a quantity of the solder. In this embodiment, the value of displacement correction is set to approximately 25 μm, and a particle size of the solder shown in FIG. 5A is set to, e.g., 30 μm.

As described above, when the slider chip 5 is subjected to self alignment and fixed on the polyimide 4a, the positioning accuracy of the pivot can be suppressed to a tolerance of the several μm order. This tolerance is extremely smaller than a conventional mechanical positioning tolerance (several-ten μm order), and the flying posture of the slider chip 5 can be thereby greatly stabilized.

Meanwhile, since each interval between the four connection terminals 6a to 6d formed on the end surface 5a of the slider chip 5 is only tens of Am, which is very small, a defect such as a solder bridge may be possibly generated between the adjacent terminals when the four connection terminals 6a to 6d are simultaneously bonded at the time of self alignment of the slider chip 5. Therefore, only the two connection terminals 6a and 6d on the both sides may be bonded to the corresponding copper wires 4b at the time of self alignment of the slider chip 5, and the slider chip 5 may be attached and fixed to the polyimide 4a. Thereafter, the remaining two connection terminals 6b and 6c may be connected to the remaining copper wires 4b.

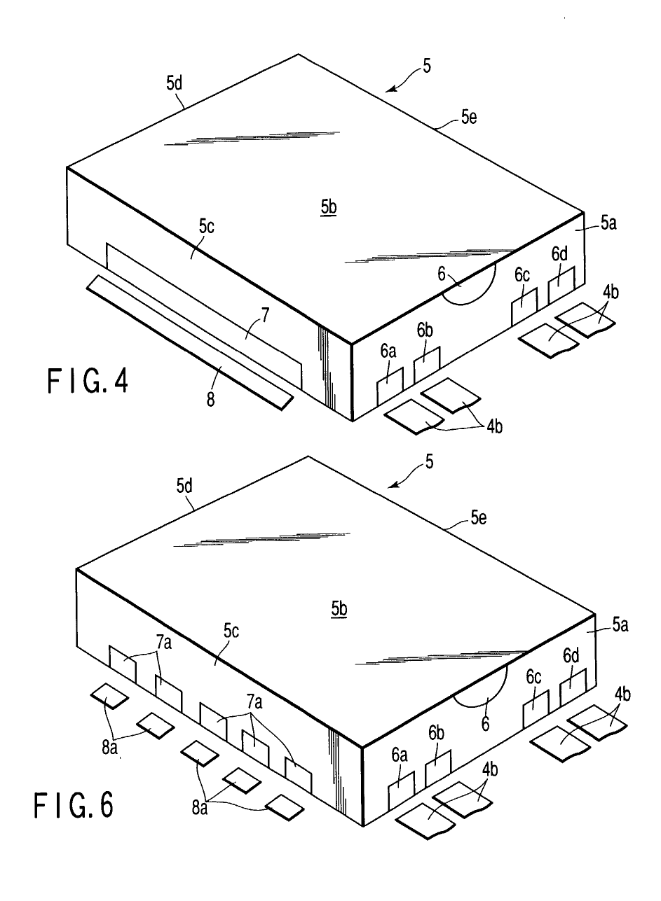

Moreover, when it is difficult to simultaneously and evenly fuse the solder having shapes such as shown in FIGS. 5A and 5B and the elongated solder (not shown) used for bonding the lands 7 and 8, a plurality of lands 7a divided into multiple pieces may be formed on the three end surfaces 5c, 5d and 5e of the slider chip 5 as shown in FIG. 6, a plurality of lands 8a may be also formed to the corresponding polyimide 4a, and the solder having shapes such as shown in FIGS. 5 may be set between these lands 7 and 8. When the lands 7a and 8a are reduced in size in this manner, although the number of laser beams used for fusing the solder must be increased, the spot shape of the beam can be minimized, and all sets of solder including the solder used for bonding the connection terminals 6a to 6d can be easily and simultaneously fused.

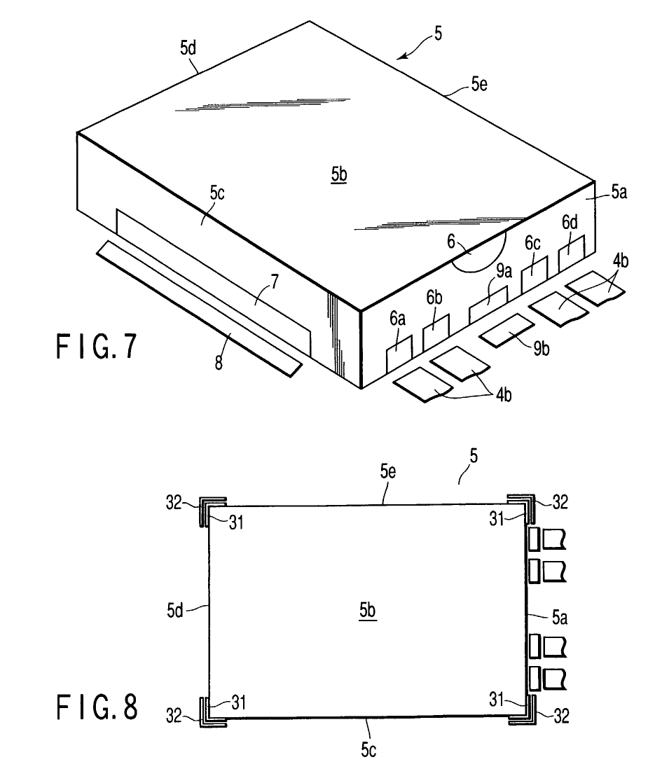

In addition, as shown in FIG. 7, a land 9a dedicated to self alignment may be additionally provided on the end surface 5a on which the connection terminals 6a to 6d of the slider chip 5 are formed. Here, the dedicated land 9a is formed between the second connection terminal 6b and the third connection terminal 6c. In this case, a land 9b having the same shape is also formed at a corresponding position of the polyimide 4a. As a result, the slider chip 5 can be subjected to self alignment by using the lands 9a and 9b without bonding the connection terminals 6a to 6d at the time of self alignment of the slider chip 5, the slider chip 5 can be attached and fixed on the polyimide 4a, the connection terminals 6a to 6d can be thereafter connected to the respective copper wires 4b. In this case, the possibility of generation of solder bridges between the respective connection terminals 6a to 6d can be eliminated in self alignment, and any other bonding material other than the solder can be selected as the bonding material for self alignment.

Additionally, as shown in FIG. 8, the slider chip 5 may be bonded to the polyimide 4a at the four corners of the slider chip 5 in order to subject the slider chip 5 to self alignment. That is, four L-shaped lands 31 which extend on the adjacent two end surfaces forming the four corner portions of the slider chip 5 are formed, and four L-shaped lands 32 are also formed at corresponding parts of the polyimide 4a. Then, the solder is set to these four pairs of the lands 31 and 32, and all sets of solder are simultaneously fused by laser, thereby subjecting the slider chip 5 to self alignment. In this case, since each pair of lands 31 and 32 restrict the degree of freedom of movement of the slider chip 5 from the two directions, the slider chip 5 can be further accurately positioned.

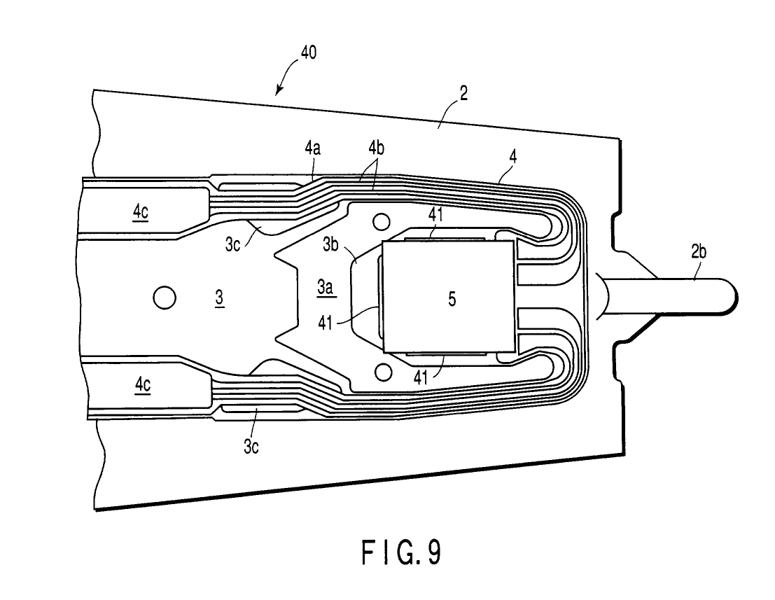

FIG. 9 is a partial bottom view showing the vicinity of an end portion of a head suspension assembly 40 (which will be referred to as an HSA 40 hereinafter) according to a second embodiment of the present invention from the direction of the magnetic disk 16. It is to be noted that the slider chip 5 is directly attached on the mount piece 3b of the flexure 3 in the HSA 40 and any other structure of the HSA 40 is the same as that of the HSA 20 in the first embodiment mentioned above.

That is, in this embodiment, the polyimide 4a of the wiring pattern 4 extending along the flexure 3 terminate in the vicinity of the copper wire 4b. Additionally, the mount piece 3b of the flexure 3 is exposed, and three lands 41 are directly formed on the exposed mount piece 3b. These lands 41 function similarly with the lands 8 in the first embodiment and subject the slider chip 5 to self alignment by utilizing the surface tension of the solder.

In this case, an advantage similar to that of the first embodiment can be obtained, and it is possible to obtain the advantage by which static electricity of the slider chip 5 is transformed to the flexure 3 through the land 7 of the slider chip 5 and the land 41 of the mount piece 3b.

As described above, according to the first and second embodiments, the slider chip 5 of the head suspension assembly can be accurately positioned on the flexure 3 by self alignment utilizing the surface tension of the solder. As a result, the flying posture of the slider chip 5 can be highly stabilized, and high-density recording with respect to the magnetic disk 16 can be enabled.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

In the first and second embodiments described above, the copper lands 7 of the slider chip 5 are soldered to the copper lands 8 (41) provided on the polyimide layer 4a (flexure 3) and are thereby set in self-alignment. Nonetheless, the lands 7 and 8 may be made of other metal that exhibits good wettability with solder. Alternatively, the solder may be replaced by material that has good wettability with copper.

For example, a fluorocarbon resin coating may be selected as a material for the lands 7 and 8 (41), and acrylic or epoxy plastic which is of an ultraviolet curing type may be selected as a bonding material in order to be used instead of solder. In this case, after subjecting the slider chip 5 to self alignment, applying ultraviolet light to the bonding material and curing it can suffice.

Further, a fluorocarbon resin coating may be applied to parts other than the lands 7 and 8 (41), and the lands 7 and 8 (41) may be adhered to each other using an acrylic or epoxy adhesive. In this case, after subjecting the slider chip 5 to self alignment, the adhesive becomes solid and fixed by irradiation of ultraviolet light. In this manner, by applying a fluorocarbon resin coating to the parts other than the lands 7 and 8 (41) in advance, the adhesive can be prevented from being accidentally attached to the parts other than the lands 7 and 8 (41).

Furthermore, in the foregoing embodiments, although description has been given as to the case where the four end surfaces 5a, 5c, 5d and 5e of the slider chip 5 are bonded to the polyimide 4a (or the mount piece 3b of the flexure 3) and the slider chip 5 is subjected to self alignment, the present invention is not restricted thereto, and bonding at least one, or more preferably, at least two end surfaces can suffice. In this case, the slider chip 5 can be likewise subjected to self alignment.

What is claimed is:

1. A head suspension assembly comprising:
a slider chip including a head which reads data with respect to a disk;
at least one first land formed on said slider chip;
a flexure which positions and mounts said slider chip;
at least one second land formed on said flexure in accordance with said at least one first land;
a suspension having said flexure attached thereto; and
solder which is provided between said first and second lands, and subjects said slider chip to self alignment and fixes said slider chip to flexure by utilizing its surface tension when fused.

2. The head suspension assembly according to claim 1, wherein at least one pair of said first lands are formed on end surfaces of said slider chip which are distanced from each other, at least one pair of said second lands are also formed in accordance with said at least one pair of said first lands, and said slider chip is pulled in opposed directions and subjected to self alignment by the surface tension of said solder set between said first and second lands.

3. The head suspension assembly according to claim 2, wherein said first and second lands are formed of metal having excellent wettability with respect to said solder.

4. The head suspension assembly according to claim 3, wherein said at least one pair of said first lands are formed with the same shape, the same size and the same material, and said at least one pair of said second lands are also formed with the same shape, the same size and the same material.

5. The head suspension assembly according to claim 4, wherein the distance between said first and second lands is 0 to 25 μm.

6. The head suspension assembly according to claim 1, wherein said at least one first land and at least one second land function as connection terminals of a signal line of said head.

7. A disk device comprising:
a spindle motor which rotatably supports a disk;
a head suspension assembly having a head which reads data with respect to said disk attached at an end thereof; and
a voice coil motor which swivels said head suspension assembly and positions said head with respect to said disk, said head suspension assembly comprising:
a slider chip including said head;
at least one first land formed on said slider chip;
a flexure which positions and mounts said slider chip;
at least one second land formed on said flexure in accordance with said at least one first land;
a suspension having said flexure attached thereto; and
solder which is provided between said first and second lands, and subjects said slider chip to self alignment and fixes said slider chip to said flexure by utilizing its surface tension when fused.

8. The disk device according to claim 7, wherein at least one pair of said first lands are formed on end surfaces of said slider chip which are distanced from each other, at least one pair of said second lands are also formed in accordance with said at least one pair of said first land, and said slider chip is pulled in opposed direction and subjected to self alignment by the surface tension of said solder set between said first and second lands.

9. The disk device according to claim 8, wherein said first and second lands are formed of metal having excellent wettability with respect to said solder.

10. The disk device according to claim 9, wherein said at least one pair of said first lands are formed with the same shape, the same size and the same material, and said at least one pair of said second lands are also formed with the same shape, the same size and the same material.

11. The disk device according to claim 10, wherein the distance between said first and second lands is 0 to 25 μm.

12. The disk device according to claim 7, wherein said at least one first land and at least one second land function as connection terminals of a signal line of said head.

13. A head suspension assembly manufacturing method which accurately positions and attaches a slider chip including a head to a flexure attached to a suspension, said method comprising:
adjusting and fixing an inclination of said suspension in such a manner that said flexure becomes substantially horizontal;
setting said slider chip on said flexure;
setting solder between at least one first land formed on said slider chip and at least one second land formed at a predetermined position on said flexure in accordance with said at least one first land; and
simultaneously fusing all sets of solder and subjecting said slider chip to self alignment with respect to said flexure by utilizing the surface tension of said solder.

14. The head suspension assembly manufacturing method according to claim 13, wherein said at least one first land is formed into at least two pieces at positions which are opposed to each other with said slider chip therebetween, and said slider chip is pulled in opposed directions and subjected to self alignment by the surface tension of said solder between said corresponding two second lands.
